(19) United States
(12) Patent Application Publication
(10) Pub. No.: US 2024/0397536 A1
(43) Pub. Date: Nov. 28, 2024

(54) METHOD AND APPARATUS FOR SIDELINK COMMUNICATION

(71) Applicant: Quectel Wireless Solutions Co., Ltd., Shanghai (CN)

(72) Inventors: Ling LYU, Shanghai (CN); Zheng ZHAO, Shanghai (CN); Zhongzhi YANG, Shanghai (CN)

(73) Assignee: Quectel Wireless Solutions Co., Ltd., Shanghai (CN)

(21) Appl. No.: 18/797,218

(22) Filed: Aug. 7, 2024

Related U.S. Application Data
(63) Continuation of application No. PCT/CN2022/127876, filed on Oct. 27, 2022.

(30) Foreign Application Priority Data
Aug. 29, 2022 (CN) 202211041222.9

(51) Int. Cl. H04W 72/40; H04W 72/0446; H04W 92/18

(52) U.S. Cl. CPC H04W 72/40; H04W 72/0446; H04W 92/18

(57) ABSTRACT

Disclosed are a method and an apparatus for side communication. The method includes: determining, by a first terminal device, a first configuration corresponding to a first FFP, where the first FFP includes a plurality of sidelink time domain units, the first configuration is used to indicate a valid sidelink time domain unit in the plurality of sidelink time domain units.

### CROSS-REFERENCE TO RELATED APPLICATIONS

The present application is a continuation of International Application No. PCT/CN2022/127876, filed on Oct. 27, 2022, which claims priority to Chinese Patent Application No. 202211041222.9, filed on Aug. 29, 2022. All of the aforementioned applications are incorporated herein by reference in their entireties.

### TECHNICAL FIELD

The present application relates to the field of communications technologies, and more specifically, to a method and an apparatus for sidelink communication.

### BACKGROUND

In an unlicensed spectrum, a channel access mode of frame based equipment (FBE) supports simultaneous channel access by a plurality of devices. When a plurality of terminal devices perform channel access in an FBE mode, transmission needs to be started at a transmission start location of a fixed frame period (FFP).

When the FFP includes a plurality of sidelink time domain units, the plurality of terminal devices contend for resources of a sidelink time domain unit located at the start location of the FFP, which may result in relatively low resource utilization of the unlicensed spectrum.

### SUMMARY

The present application provides a method and an apparatus for side communication, which help improve resource utilization of an unlicensed spectrum.

According to a first aspect, a method for sidelink communication is provided, including: determining, by a first terminal device, a first configuration corresponding to a first FFP, where the first FFP includes a plurality of sidelink time domain units, the first configuration is used to indicate a valid sidelink time domain unit in the plurality of sidelink time domain units.

According to a second aspect, an apparatus for sidelink communication is provided, the apparatus is a first terminal device and includes: a determining unit, configured to determine a first configuration corresponding to a first FFP, where the first FFP includes a plurality of sidelink time domain units, and the first configuration is used to indicate a valid sidelink time domain unit in the plurality of sidelink time domain units.

According to a third aspect, a communications apparatus is provided and includes a memory and a processor, where the memory is configured to store a program, and the processor is configured to invoke the program in the memory to perform the method according to the first aspect.

According to a fourth aspect, a communications apparatus is provided, including a processor, configured to invoke a program from a memory to execute the method according to the first aspect.

According to a fifth aspect, a chip is provided, and the chip includes a processor configured to invoke a program from a memory to cause a device installed with the chip to perform the method according to the first aspect.

According to a sixth aspect, a computer-readable storage medium is provided, and the computer-readable storage medium stores a program that causes a computer to perform the method according to the first aspect.

According to a seventh aspect, a computer program product is provided, and the computer program product includes a program that causes a computer to perform the method according to the first aspect.

According to an eighth aspect, a computer program is provided, where the computer program causes a computer to perform the method according to the first aspect.

In this embodiment of the present application, a first configuration corresponding to a first FFP may indicate a valid sidelink time domain unit in the first FFP. After determining the first configuration, a first terminal device may perform channel access based on the valid sidelink time domain unit. It may be learned that a plurality of terminal devices may determine, based on a configuration, a time domain location at which channel access is to be performed, and do not need to all contend for a same sidelink time domain unit, thereby helping improve resource utilization of an unlicensed spectrum.

### BRIEF DESCRIPTION OF THE DRAWINGS

FIG. 1 shows a wireless communications system to which an embodiment of the present application is applied.

FIG. 2 is a schematic diagram of a slot structure of sidelink that does not carry a PSFCH.

FIG. 3 is a schematic diagram of a slot structure of sidelink that carries a PSFCH.

FIG. 4 is a schematic diagram of a frame structure for performing channel access based on an FBE mode.

FIG. 5 is a schematic diagram of an FBE structure of slot aggregation used when a subcarrier spacing is 30 KHz.

FIG. 6 is a schematic flowchart of a method for sidelink communication according to an embodiment of the present application.

FIG. 7 is a schematic structural diagram of a plurality of FFP configurations used when a subcarrier spacing is 30 kHz according to an embodiment of the present application.

FIG. 8 is a schematic block diagram of an apparatus for sidelink communication according to an embodiment of the present application.

FIG. 9 is a schematic diagram of a structure of a communications apparatus according to an embodiment of the present application.

### DETAILED DESCRIPTION OF THE EMBODIMENTS

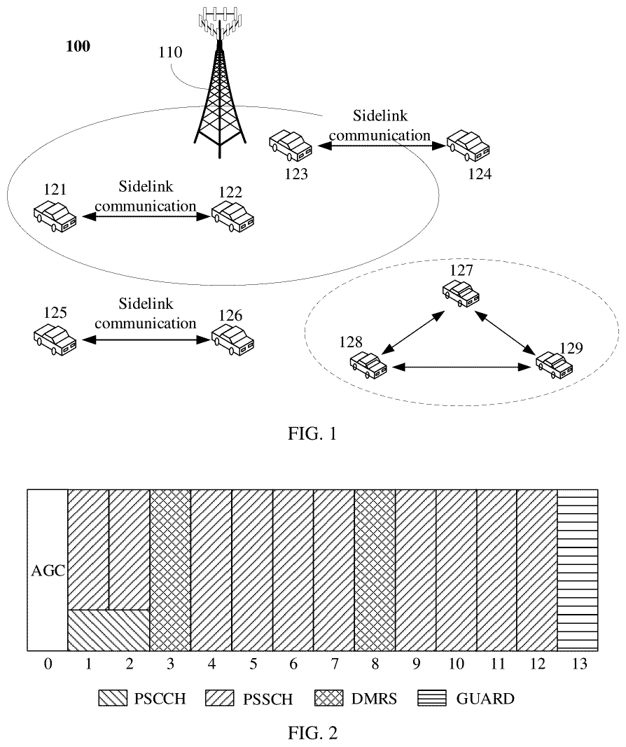

The technical solutions in the present application are described below with reference to the accompanying drawings. For case of understanding, the terms and communication processes involved in the present application are first described below with reference to FIG. 1 to FIG. 4.

FIG. 1 is an example diagram of a system architecture of a wireless communications system 100 to which the embodiments of the present application are applicable. The wireless communications system 100 may include a network device 110 and terminal devices 121 to 129. The network device 110 may provide communication coverage for a specific geographic area, and may communicate with terminals within the coverage area.

In some implementations, terminal devices may communicate with each other through sidelink (SL). The sidelink communication may also be referred to as proximity services (ProSe) communication, unilateral communication, side link communication, device-to-device (D2D) communication, or the like.

In other words, sidelink data is transmitted between terminal devices over sidelink. The sidelink data may include data and/or control signaling. In some implementations, the sidelink data may be, for example, a physical sidelink control channel (PSCCH), a physical sidelink shared channel (PSSCH), a PSCCH demodulation reference signal (DMRS), a PSSCH DMRS, or a physical sidelink feedback channel (PSFCH).

Several common sidelink communication scenarios are described below with reference to FIG. 1. Sidelink communication may include three scenarios depending on whether the terminal devices in the sidelink are within the coverage of the network device. In scenario 1, the terminal devices perform sidelink communication within the coverage of the network device. In scenario 2, some of the terminal devices perform sidelink communication within the coverage of the network device. In scenario 3, the terminal devices perform sidelink communication outside the coverage of the network device.

As shown in FIG. 1, in scenario 1, terminal devices 121 and 122 may communicate with each other over sidelink, and the terminal devices 121 and 122 are both within the coverage of the network device 110, or in other words, the terminal devices 121 and 122 are both within the coverage of the same network device 110. In this scenario, the network device 110 may send configuration signaling to the terminal devices 121 and 122, and accordingly, the terminal devices 121 and 122 communicate with each other over the sidelink based on the configuration signaling.

As shown in FIG. 1, in scenario 2, terminal devices 123 and 124 may communicate with each other over sidelink, and the terminal device 123 is within the coverage of the network device 110, while the terminal device 124 is outside the coverage of the network device 110. In this scenario, the terminal device 123 receives configuration information from the network device 110, and communicates over the sidelink based on a configuration of the configuration signaling. However, since the terminal device 124 is outside the coverage of the network device 110, the terminal device 124 cannot receive the configuration information from the network device 110. In this case, the terminal device 124 may obtain a configuration of the sidelink communication based on preconfigured configuration information and/or the configuration information sent by the terminal device 123 within the coverage, so as to communicate with the terminal device 123 over the sidelink based on the obtained configuration.

In some cases, the terminal device 123 may send the configuration information to the terminal device 124 through a physical sidelink broadcast channel (PSBCH), so as to configure the terminal device 124 to communicate over the sidelink.

As shown in FIG. 1, in scenario 3, terminal devices 125 to 129 are all outside the coverage of the network device 110 and cannot communicate with the network device 110. In this case, all the terminal devices may perform sidelink communication based on preconfiguration information.

In some cases, the terminal devices 127 to 129 outside the coverage of the network device may form a communication cluster, and the terminal devices 127 to 129 in the communication cluster may communicate with each other. In addition, the terminal device 127 in the communication cluster may serve as a central control node, also referred to as a cluster header (CH). Correspondingly, the other terminal devices in the communication cluster may be referred to as “cluster members”.

The terminal device 127 as the CH may have one or more of the following functions: responsible for establishment of the communication cluster; joining and leaving of the cluster members; resource coordination, allocation of sidelink transmission resources for the cluster members, and reception of sidelink feedback information from the cluster members; resource coordination with another communication cluster; and other functions.

It should be noted that FIG. 1 exemplarily shows a network device and a plurality of terminal devices. Optionally, the wireless communications system 100 may include a plurality of network devices, and another number of terminal devices may be included in the coverage of each network device, which is not limited in embodiments of the present application.

Optionally, the wireless communications system 100 may further include other network entities such as a network controller and a mobility management entity, which is not limited in the embodiments of the present application.

It should be understood that the technical solutions in the embodiments of the present application may be applied to various communications systems, for example, a 5th generation (5G) system or new radio (NR) system, a long term evolution (LTE) system, an LTE frequency division duplex (FDD) system, and an LTE time division duplex (TDD). The technical solutions provided in the present application may also be applied to future communications systems, such as a 6th generation mobile communications system and a satellite communications system.

The terminal device in the embodiments of the present application may also be referred to as user equipment (UE), an access terminal, a subscriber unit, a subscriber station, a mobile site, a mobile station (MS), a mobile terminal (MT), a remote station, a remote terminal, a mobile device, a user terminal, a wireless communications device, a user agent, a user apparatus or the like. The terminal device in the embodiments of the present application may be a device providing a user with voice and/or data connectivity and capable of connecting people, objects, and machines, such as a handheld device or vehicle-mounted device having a wireless connection function. The terminal device in the embodiments of the present application may be a mobile phone, a tablet computer (Pad), a notebook computer, a palmtop computer, a mobile internet device (MID), a wearable device, a vehicle, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the terminal device may be used to act as a base station. For example, the terminal device may act as a scheduling entity, which provides a sidelink signal between terminal devices in vehicle-to-everything (V2X) or D2D, or the like. For example, a cellular phone and a car communicate with each other using sidelink data. A cellular phone and a smart home device communicate with each other, without the relay of a communication signal through a base station.

The network device in the embodiments of the present application may be a device for communicating with the terminal device. The network device may also be referred to as an access network device or a wireless access network device. For example, the network device may be a base station. The network device in the embodiments of the present application may be a radio access network (RAN) node (or device) that connects the terminal device to a wireless network. The base station may broadly cover various names in the following, or may be interchangeable with one of the following names, for example: a NodeB, an evolved NodeB (eNB), a next generation NodeB (gNB), a relay station, a transmitting and receiving point (TRP), a transmitting point (TP), an access point (AP), a master eNB (MeNB), a secondary eNB (ScNB), a multi-standard radio (MSR) node, a home base station, a network controller, an access node, a radio node, a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that assumes the function of a base station in D2D, V2X, and machine-to-machine (M2M) communications, a network-side device in a 6G network, a device that assumes the function of a base station in a future communications system, or the like. The base station may support networks of the same or different access technologies. A specific technology and specific device form used by the network device are not limited in the embodiments of the present application.

The base station may be fixed or mobile. For example, a helicopter or an unmanned aerial vehicle may be configured to act as a mobile base station, and one or more cells may move according to the position of the mobile base station. In other examples, a helicopter or an unmanned aerial vehicle may be configured to serve as a device in communication with another base station.

In some deployments, the network device in the embodiments of the present application may be a CU or a DU, or the network device includes a CU and a DU. The gNB may further include an AAU.

The network device and the terminal device may be deployed on land, including indoor or outdoor, handheld or vehicle-mounted; or may be deployed on water; or may be deployed on an airplane, a balloon, and a satellite in the air. In the embodiments of the present application, a scenario where the network device and the terminal device are located is not limited.

It should be understood that all or some of the functions of the communications device in the present application may also be implemented by software functions running on hardware, or by virtualization functions instantiated on a platform (such as a cloud platform).

The spectrum used by the wireless communications system 100 includes licensed spectrum and unlicensed spectrum. An important direction for expansion of the communications systems to different fields is the use of unlicensed spectrum. For example, NR deployed on the unlicensed spectrum is referred to as NR-U.

With development of sidelink communications technologies, using unlicensed spectrum on the sidelink becomes a focus of research. For example, the 3rd generation partnership project (3GPP) protocol Rel-18 has approved a project RP-213678 on sidelink enhancements, where sidelink communication over unlicensed spectrum (SL-U) is important research content in this project.

The project content of RP-213678 is used as an example. For development of the SL-U, reference is made to the following recommendation: sidelink communication is studied and specified to be supported on unlicensed spectrum for mode 1 and mode 2, and an operation of a Uu interface for the mode 1 is limited to licensed spectrum (RAN 1, RAN 2, and RAN 4).

First, a channel access mechanism from NR-U may be used for unlicensed communication of sidelink.

In boundaries of unlicensed channel access mechanism and operation, applicability of sidelink resource reservation from Rel-16/Rel-17 to sidelink unlicensed operation is assessed.

Resource allocation mechanisms for Rel-17 are not specifically enhanced.

If an existing NR-U channel access framework does not support a required SL-U function, working groups (WGs) will make appropriate recommendations for RAN approval.

Second, for a physical channel design framework, NR sidelink physical channel structures and procedures need to be changed, so as to implement communication on an unlicensed spectrum.

Existing NR sidelink and NR-U channel structures may be used as a baseline.

Third, an existing NR SL feature is not specifically enhanced.

Fourth, the study should focus on unlicensed frequency bands (n46 and n96/n102) in a frequency range 1 (FR1), and will be completed by RAN #98.

It may be learned from the foregoing recommendations that the previous design will be considered as far as possible in design of the SL-U. With reference to FIG. 2 to FIG. 4, the following describes the foregoing related technologies that may be used. Related technologies include an NR-U channel access mechanism and a sidelink slot structure related to NR sidelink and an NR-U channel structure.

### Slot Structure of Sidelink

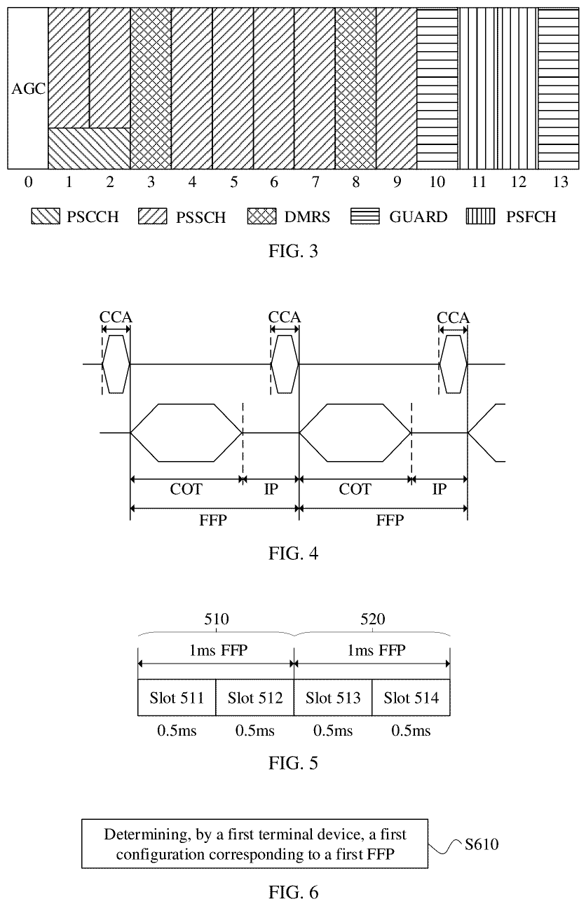

Communication of NR sidelink is based on a periodic time sequence structure, namely, a slot. Some protocols (such as Rel-16) define a slot structure of sidelink. With reference to FIG. 2 and FIG. 3, the following specifically describes the slot structure of sidelink by using a slot structure including 14 symbols as an example. FIG. 2 shows a slot structure of sidelink that does not carry a PSFCH. FIG. 3 shows a slot structure of sidelink that carries a PSFCH.

Referring to FIG. 2, in time domain, a PSCCH may occupy two or three sidelink symbols starting from the second sidelink symbol (for example, an orthogonal frequency division multiplexing (OFDM) symbol) of a slot. In frequency domain, the PSCCH may occupy a plurality of physical resource blocks (PRBs). Usually, in order to reduce complexity of blind detection of the PSCCH by a terminal device, configuration of only one combination of quantity of PSCCH symbols and quantity of PRBs is allowed in one resource pool. In addition, because a sub-channel is a minimum granularity of PSSCH resource allocation specified in sidelink, a quantity of PRBs occupied by the PSCCH must be less than or equal to a quantity of PRBs included in a sub-channel in a resource pool, so as to avoid additional limitation on resource selection or allocation of the PSSCH.

Still referring to FIG. 2, in time domain, the sidelink symbol occupied by the PSSCH alternatively starts from the second sidelink symbol of a slot, and ends at the penultimate sidelink symbol. The PSSCH supports a time domain DMRS pattern of a plurality of symbols. A time domain DMRS pattern of two symbols is configured in the PSSCH shown in FIG. 2, that is, the fourth sidelink symbol and the ninth sidelink symbol. In frequency domain, the PSSCH occupies K sub-channels, cach sub-channel includes N consecutive PRBs, and K and N are positive integers.

Generally, the first sidelink symbol in a slot is a repetition of the second sidelink symbol, and the first sidelink symbol may be used as an automatic gain control (AGC) symbol. Data on the AGC symbol is usually not used for data demodulation. The last sidelink symbol in a slot is a guard symbol.

Referring to FIG. 3, when the slot structure carries a PSFCH, the penultimate sidelink symbol and the antepenultimate sidelink symbol in the slot structure are used for transmission of a PSFCH. The antepenultimate sidelink symbol may be used as an AGC symbol of the PSFCH. In addition, a guard symbol needs to be reserved following both the PSSCH and the PSFCH.

### NR-U Channel Access Mechanism

In an unlicensed spectrum of the NR, two types of devices are defined, which are respectively a load based equipment (LBE) and an FBE. Both the LBE and the FBE follow a channel access mechanism of listen before talk (LBT).

LBE-based LBT is also referred to as dynamic channel monitoring. A principle is that a communications device performs LBT on a carrier of an unlicensed spectrum after a service arrives, and starts signal transmission on the carrier after the LBT succeeds. The LBE is applicable to an unlicensed spectrum where a cellular communications system coexists with another communications system, and the another communications system is, for example, a wireless fidelity (Wi-Fi) system on the unlicensed spectrum.

FBE-based LBT is also referred to as semi-static channel monitoring. A channel access mechanism of the FBE may increase frequency reuse, and support a plurality of devices in performing channel monitoring synchronously. However, in network deployment, there are relatively high requirements for interference environment and synchronization. The FBE is more applicable to a case in which no other communications system exists on the unlicensed spectrum. For example, the FBE may be used in a local plant network where presence of different communications systems (such as the Wi-Fi system) is controllable.

In a semi-static channel access mode, a frame structure appears periodically, that is, a channel resource that may be used by a communications device to transmit a service appears periodically. A frame structure includes an FFP, a channel occupancy time (COT), and an idle period (IP).

For application of the FBE on the unlicensed spectrum, the European telecommunications standards institute (ETSI) regulates the FFP, COT, and idle period in a frame structure. With reference to FIG. 4, the following describes in detail a frame structure of the FBE and a requirement for various parameters. FIG. 4 is an example of the FBE frame structure.

Referring to FIG. 4, a frame structure of the FBE is a periodic time sequence structure based on an FFP. As shown in FIG. 4, each FFP includes two parts: a COT and an IP.

Generally, an FFP is limited to a range of 1 millisecond to 10 milliseconds. Transmission performed by a device must start from a start location of the FFP. A structure or configuration of the FFP cannot be changed more than once every 200 milliseconds.

The COT of an FFP is defined as a duration in which a node may perform continuous transmission on a given channel without reevaluating channel availability. The duration of the COT is at most 95% of the FFP, and the COT must be followed by an IP.

As shown in FIG. 4, an IP is located at a tail of an FFP. The IP includes an observation slot in which clear channel assessment (CCA) is performed. A duration of an IP must be greater than 5% of a duration of a COT and is at least 100 microseconds.

Based on the frame structure shown in FIG. 4, a communications device performs LBT on a channel in an idle period. If the LBT succeeds, the COT in a next FFP may be used to transmit signals. If the LBT fails, the COT in the next FFP cannot be used to transmit signals.

The foregoing describes a slot structure of sidelink and an FBE channel access mode in NR-U recommended in design of SL-U. To better follow the previous design, the inventors make a systematic analysis, and provide the present application on such a basis. Details are described below.

As mentioned above, both sidelink communication and FBE channel access are based on a periodic time structure. Further analysis shows that the slot structure of sidelink matches an FFP structure very well.

For example, a requirement that FBE transmission must start at a start location of an FFP may be met by aligning a start location of an FBE frame with a start location of a sidelink slot. For another example, all terminal devices for sidelink communication need to be aligned in a time to perform operation/transmission of the sidelink. This requirement may be met by aligning FBE structures of different users. Therefore, a terminal device on sidelink may perform channel access on unlicensed spectrum by using an FBE mode.

For another example, in NR, transmission of sidelink supports a plurality of parameter sets, and a plurality of subcarrier spacing (SCS) may be represented as SCS=15×2^{μ} (μ≥0). In a case in which subcarrier spacing of sidelink is 15 kHz (μ=0), a slot of the sidelink is 1 millisecond, which completely matches a specification requirement that a minimum of FFP is 1 millisecond.

For another example, the last symbol of a sidelink slot is a guard symbol, in which no transmission is performed, and this is also consistent with an idle period of the FFP. However, the idle period has a time requirement (greater than 5% of a duration of a COT, and greater than 100 microseconds), a guard symbol of one symbol duration cannot directly meet the requirement. However, this is easy to solve for sidelink of NR because a range of a transmission symbol on sidelink is configurable in the NR. For example, sl-LengthSymbols=12 and sl-StartSymbol=0 may be configured to ensure that the requirement of an idle period is met. The two configurations may indicate that, in one slot, 12 symbols starting from the first symbol may be used for sidelink transmission, and the last two symbols are not used for any transmission. When the subcarrier spacing is 15 kHz, duration of each symbol is 66.7 microseconds, and duration of two symbols not used for transmission is greater than 100 microseconds, thereby meeting a requirement of an idle period.

However, the foregoing solution is based on a case in which a sidelink slot is 1 millisecond. For a configuration with a higher subcarrier spacing, a sidelink slot will be less than 1 millisecond, that is, less than a minimum FBE frame length allowed by a regulation. For example, when the subcarrier spacing is 30 kHz, a duration of a sidelink slot is 0.5 millisecond, which is less than a requirement of an FFP frame length being 1 millisecond.

For this problem, slot aggregation is a possible solution. For example, when μ>0 for the subcarrier spacing, an FFP is set to 1 millisecond, and each FFP has 2^{μ} sidelink slots. It should be noted that when a terminal device performs channel access based on an FBE structure of slot aggregation, allocation of minimum time domain resources of the sidelink is changed to 2^{μ} slots.

An FFP is set to 1 millisecond, and when the subcarrier spacing is 30 kHz, μ=1. The following describes an FBE structure of slot aggregation with reference to FIG. 5 by using the foregoing description as an example.

Referring to FIG. 5, a subcarrier spacing is 30 kHz, and duration of each of a slot 511 to a slot 514 is 0.5 millisecond. The slot 511 and the slot 512 are aggregated to form an FFP 510 of 1 millisecond, and the slot 513 and the slot 514 are aggregated to form an FFP 520 of 1 millisecond. The first symbol of the slot 511 is a start time domain location of the FFP 510, and some or all symbols in the slot 512 may be an idle period of the FFP 510. Similarly, the first symbol of the slot 513 is a start time domain location of the FFP 520, and some or all symbols in the slot 514 are an idle period of the FFP 520.

As mentioned above, the FBE channel access mode supports frequency multiplexing of a plurality of devices. When a plurality of devices are configured with the FBE structure shown in FIG. 5, all devices are required by regulations to start transmission from the first symbol of the slot 511 or the slot 513 for transmission. In other words, all devices contend for a same time domain location in the FFP, which is prone to resource collisions.

Further, in a case in which the sidelink slot is less than 1 millisecond, a resource allocation granularity is at least two slots. When a terminal device does not have a large quantity of service transmission requirements, resources of the second slot may be wasted. In addition, because the resource allocation granularity is increased from one slot to 2^{μ} slots, timing of uplink and downlink switching performed by a communications device is reduced, which causes more severe half-duplex constraint impact.

Therefore, when a plurality of terminal devices on sidelink simultaneously contend for an FFP resource formed by aggregation of a plurality of time domain units, there is a case in which the first time domain unit is overly congested and subsequent time domain units are not fully utilized, resulting in low channel resource utilization.

To solve some or all of the foregoing problems, embodiments of the present application provide a method and an apparatus for sidelink communication. The method is an efficient resource allocation manner based on FBE channel access. The embodiments of the present application are implemented based on the foregoing analysis. The foregoing analysis is not a conventional technology, but should be considered as a part, contributing to the conventional technology, of the present application.

With reference to FIG. 6, the method for sidelink communication provided in embodiments of the present application is specifically described.

Referring to FIG. 6, in Step S610, the first terminal device determines a first configuration of a first FFP.

The first terminal device is a terminal device that performs sidelink communication. The first terminal device may be a device that needs to perform channel access and data transmission in sidelink communication.

The first terminal device may perform unicast communication, groupcast communication, or broadcast communication with other terminal devices. In some embodiments, the first terminal device may be a device that initiates unicast communication. In some embodiments, the first terminal device may be a cluster header that initiates groupcast or broadcast communication, or may be a cluster member in the groupcast or broadcast communication. For example, in V2X, the first terminal device may be a vehicle that performs groupcast communication with another vehicle, or may be another vehicle that receives a signal transmitted by a cluster header in groupcast communication.

The first terminal device may be a terminal device within coverage of a network device, or may be a terminal device outside coverage of the network device. In some embodiments, the first terminal device may perform sidelink communication based on a resource pool configured by the network device. In some embodiments, the first terminal device may perform sidelink communication by using a preconfigured resource pool.

In some embodiments, a resource pool of the first terminal device may be a sidelink resource pool configured with a subcarrier spacing greater than 15 kHz. For example, the subcarrier spacing of the sidelink resource pool may be 30 kHz, may be 60 kHz, or may be 120 kHz.

The first terminal device may perform channel access in an FBE mode. In some embodiments, the first terminal device may perform channel access and sidelink transmission by acknowledging configuration of the first FFP in the resource pool.

A duration of the first FFP meets a specification requirement. In some embodiments, the duration of the first FFP may be 1 millisecond, which substantially matches a duration of a slot.

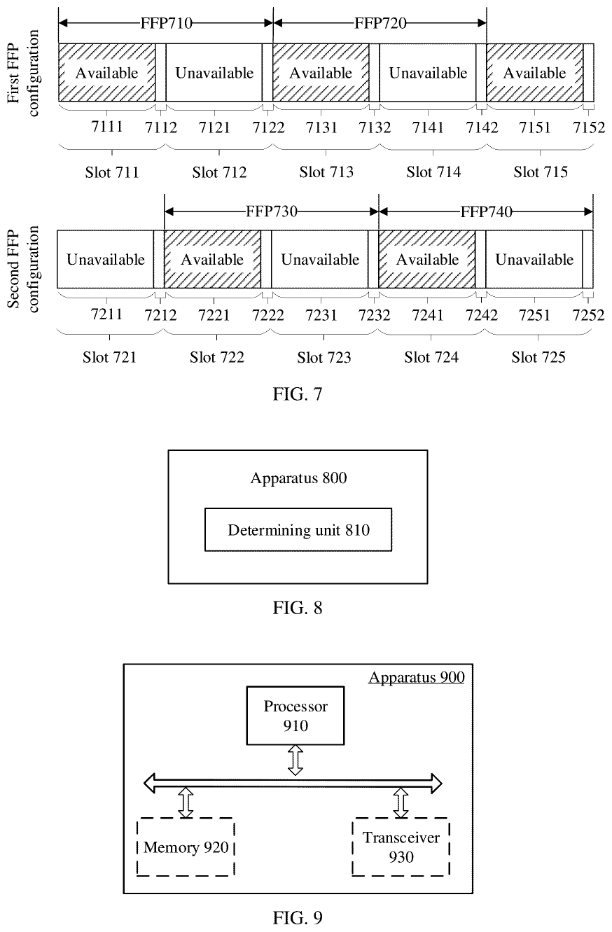

The first FFP may include a plurality of sidelink time domain units. In some embodiments, the sidelink time domain units may be slots. For example, the first FFP may include a plurality of slots. A symbol used for transmission in the first slot may be used as a COT of an FFP, and a guard symbol of the last slot may be used for performing CCA in an idle period. The following is specifically described with reference to FIG. 7. In some embodiments, the sidelink time domain unit may be a plurality of symbols. First several sidelink time domain units in the plurality of sidelink time domain units may form a COT of the first FFP, and the last sidelink time domain unit may be an idle period of the first FFP.

A quantity of sidelink time domain units in the first FFP may be determined based on one or more pieces of information.

In some embodiments, a quantity of sidelink time domain units in the first FFP may be determined based on a subcarrier spacing of sidelink. In a possible implementation, the first FFP may include 2^{μ} sidelink time domain units, where μ may be a parameter determined based on a subcarrier spacing. In other words, μ may have a same meaning as μ in the subcarrier spacing calculation formula (15×2^{μ}). For example, when the subcarrier spacing is 30 kHz, μ in 15×2^{μ} is 1, 2^{μ} is 2, and the first FFP includes two sidelink time domain units.

In some embodiments, a quantity of sidelink time domain units in the first FFP may be determined based on a duration of a sidelink time domain unit and a duration of the first FFP. For example, when the duration of the sidelink time domain unit is 0.25 millisecond, a first FFP with 1 millisecond includes four sidelink time domain units, and a first FFP with 2 milliseconds includes eight sidelink time domain units.

The plurality of sidelink time domain units may include a valid sidelink time domain unit. The valid sidelink time domain unit is a time domain resource that may be used by the first terminal device for transmission, and may also be referred to as an available sidelink time domain unit. In contrast, the plurality of sidelink time domain units may further include an invalid sidelink time domain unit, namely, an unavailable sidelink time domain unit. For a terminal device, the unavailable sidelink time domain unit may be idle or may be a time domain resource that is not used for transmission.

Some or all of the plurality of sidelink time domain units may be valid sidelink time domain units. Some of the time domain units may be one sidelink time domain unit, or may be a plurality of sidelink time domain units.

In some embodiments, the first sidelink time domain unit in the first FFP is a valid sidelink time domain unit, and all other sidelink time domain units are invalid time domain units. The valid sidelink time domain unit is a COT in the first FFP. The valid sidelink time domain unit has a same start location as the first FFP. Therefore, a start location of the valid sidelink time domain unit may be a time domain location at which the first terminal device performs channel access. The FFP 510 in FIG. 5 is used as an example. The slot 511 is a valid sidelink time domain unit, and the first terminal device may perform transmission starting from the first symbol of the slot 511.

In some embodiments, a plurality of sidelink time domain units in the first FFP are valid sidelink time domain units, and a duration of a COT is relatively long. For example, a valid sidelink time domain unit in the first FFP may be a plurality of consecutive sidelink time domain units, or may be a plurality of sidelink time domain units configured with intervals.

In some embodiments, whether the plurality of sidelink time domain units in the first FFP are valid may be configured. Adjustment of the configuration may be made no more than once every 200 milliseconds as required by regulations. In some embodiments, the network device may specify a valid sidelink time domain unit of the first FFP in the resource pool through configuration/preconfiguration.

In some embodiments, validity of the plurality of sidelink time domain units in the first FFP may be determined based on the terminal device. In other words, the validity of the sidelink time domain unit may depend on a terminal device. For example, a sidelink time domain unit that is valid for the first terminal device may be an invalid sidelink time domain unit for another terminal device.

A valid sidelink time domain unit in the first FFP may be indicated by using the first configuration. The first configuration may be the foregoing configuration performed by the network device for the first FFP, or may be referred to as an FFP configuration or an FBE configuration. In some embodiments, the first configuration may indicate information such as a start time domain location and a duration of a valid sidelink time domain unit in the first FFP. After determining the first configuration, the first terminal device may start to perform transmission according to the start time domain location that is indicated.

In some embodiments, the first configuration may further indicate other configuration information corresponding to the first FFP. For example, the first configuration may indicate a start time domain location, a duration, and an end time domain location of the first FFP. For example, the first configuration may indicate a start location and a duration of each of a COT and an idle period in the first FFP. For example, the first configuration may indicate a duration and a start location for performing CCA in the FFP. For example, the first configuration may indicate a quantity of sidelink time domain units included in the first FFP.

It may be learned from the foregoing that the first terminal device may determine a valid sidelink time domain unit according to the indication of the first configuration, so as to perform channel access and sidelink transmission. Therefore, the first terminal device does not need to contend for a same channel resource with another terminal device. Further, in a duration of one FFP, different valid time domain units may be respectively configured for the plurality of terminal devices. Time domain locations at which the plurality of terminal devices start to transmit are different, which helps reduce congestion at a same time domain unit, thereby improving resource utilization.

To use the time domain units in the FFP more evenly for transmission, valid sidelink time domain units corresponding to the plurality of terminal devices may be staggered. Alternatively, staggering may be that valid sidelink time domain units are not at a same time domain location. Being staggered of a plurality of valid time domain units in the FFP may also be referred to as FBE staggering. In some embodiments, valid sidelink time domain units corresponding to a plurality of terminal devices may be staggered by means of offset.

As mentioned above, the first configuration may indicate a valid sidelink time domain unit in the first FFP. The information indicated by the first configuration may further include an offset status of a valid sidelink time domain unit. In some embodiments, the first configuration may directly indicate a time domain location obtained after offset of the valid sidelink time domain unit in the first FFP. In some embodiments, the first configuration may include a first parameter. The first parameter may be used to indicate an offset of a time domain unit. The first terminal device may determine the valid sidelink time domain unit in the first FFP based on the offset indicated by the first parameter.

In a possible implementation, the offset indicated by the first parameter may be configured, or may be determined based on a service requirement. For example, the first parameter may be configured by the network device based on a start location of a resource pool, so as to indicate an offset of a valid sidelink time domain unit relative to the start location. For another example, the first parameter may indicate an offset of a valid sidelink time domain unit in the first FFP relative to a channel monitoring location of the first terminal device.

In some embodiments, a granularity of offset of the valid sidelink time domain unit may be determined based on the sidelink time domain unit. In a possible implementation, when the sidelink time domain unit is a slot, offset of the time domain unit may use the slot as a granularity. For example, when the first FFP is formed by aggregation of four slots, the offset may be one slot or a plurality of slots less than 4.

By means of offset, a time domain location of the valid sidelink time domain unit in the first FFP may be adjusted, so that a plurality of time domain locations for channel access may be implemented in a duration of one FFP.

For a plurality of time domain locations for channel access in a duration of one FFP, the first FFP may introduce a plurality of corresponding configurations into a resource pool of the first terminal device. The first terminal device may perform channel access and data transmission by selecting a proper time domain unit corresponding to a first configuration according to a requirement.

When the first FFP is corresponding to a plurality of configurations, the plurality of configurations may respectively indicate valid sidelink time domain units that are staggered, so that the plurality of terminal devices may start to perform transmission at different time domain locations by using different configurations. For example, the first FFP may be corresponding to four configurations, and each configuration indicates a channel access location different from another configuration. Therefore, in a duration of one FFP, four terminal devices may perform channel access.

In some embodiments, a structure of a plurality of configurations corresponding to the first FFP may be configured/preconfigured by the network device. The network device may better coordinate requirements of a plurality of terminal devices, thereby improving utilization of an entire spectrum. For example, when a plurality of terminal devices in coverage of the network device perform channel access, the network device may introduce, into a resource pool, a plurality of configurations corresponding to an FFP. The plurality of configurations may correspond to an FFP architecture that implements staggering of valid sidelink time domain units. The plurality of terminal devices may select an applicable configuration for transmission. For example, when a plurality of terminal devices outside coverage of the network device perform channel access, a plurality of configurations corresponding to an FFP may be included in a preconfigured resource pool.

In some embodiments, the structure of a plurality of configurations corresponding to the first FFP may be specified in a standard. For example, that valid sidelink time domain units are staggered in the plurality of configurations may be specified in some protocols.

A quantity of a plurality of configurations corresponding to the first FFP may be determined based on one or more pieces of information.

In some embodiments, a quantity of the plurality of configurations corresponding to the first FFP may be determined based on a subcarrier spacing of sidelink. In a possible implementation, the first FFP may be corresponding to 2^{μ} configurations, where μ may be a parameter determined based on the subcarrier spacing. For example, when the subcarrier spacing is 60 kHz, μ in 15×2^{μ} is 2, 2^{μ} is 4, and the first FFP is corresponding to four configurations.

In some embodiments, a quantity of configurations corresponding to the first FFP may be determined based on a quantity of sidelink time domain units included in the first FFP. In a possible implementation, a quantity of configurations corresponding to the first FFP may be the same as a quantity of sidelink time domain units. For example, when the first FFP includes two sidelink time domain units, there may be correspondingly two configurations. In a possible implementation, a quantity of configurations corresponding to the first FFP may be further less than a quantity of sidelink time domain units. For example, when the first FFP includes four sidelink time domain units, there may be correspondingly two configurations.

In some embodiments, a quantity of configurations corresponding to the first FFP may be determined based on a time granularity of offset of the first FFP. For example, when the offset of the first FFP uses one sidelink time domain unit as a granularity, a quantity of configurations is less than or equal to a quantity of sidelink time domain units included in the first FFP. For another example, when the offset of the first FFP uses a half-sidelink time domain unit as a granularity, a quantity of configurations may be greater than a quantity of sidelink time domain units included in the first FFP. For another example, when the offset of the first FFP uses two sidelink time domain units as a granularity, a quantity of configurations is less than or equal to half of the quantity of sidelink time domain units included in the first FFP.

In some embodiments, a quantity of a plurality of configurations corresponding to the first FFP may further be determined based on a duration of the first FFP. For example, when the duration of the first FFP is relatively long, the first FFP may be corresponding to a relatively large quantity of configurations.

In some embodiments, the quantity of the plurality of configurations corresponding to the first FFP may further be determined by considering a quantity of terminal devices. For example, when there is a relatively large quantity of terminal devices that perform channel access, the network device may introduce a relatively large quantity of configurations.

In some embodiments, valid time domain units corresponding to the plurality of configurations may have different offsets. In a possible implementation, when the first FFP is corresponding to N configurations, an offset of the ith configuration is i−1 sidelink time domain units, and a value of i is an integer from 1 to N. For example, when the first FFP that includes four sidelink time domain units is corresponding to four configurations, offsets of the four configurations may be respectively 0 to 3 sidelink time domain units.

For case of understanding, with reference to FIG. 7, the following uses an example in which an FFP is 1 millisecond, a subcarrier spacing is 30 kHz, and a sidelink time domain unit is a slot to specifically describe a case in which the first FFP corresponds to a plurality of configurations with different offsets. In addition, the foregoing structure of the FFP obtained after slot aggregation is described with reference to FIG. 7.

Referring to FIG. 7, a resource pool includes two FFP configurations, which are respectively the first FFP configuration and the second FFP configuration. FFPs corresponding to the first FFP configuration include an FFP 710 and an FFP 720. FFPs corresponding to the second FFP configuration include an FFP 730 and an FFP 740.

As shown in FIG. 7, there are five slots in cach configuration. The FFP 710 includes a slot 711 and a slot 712, the FFP 720 includes a slot 713 and a slot 714, and a slot 715 may belong to a next FFP. The FFP 730 includes a slot 722 and a slot 723, the FFP 740 includes a slot 724 and a slot 725, and a slot 721 may not belong to an FFP.

As shown in FIG. 7, each slot includes two time periods. The slot 715 is used as an example, and the slot 715 includes a time period 7151 and a time period 7152. The time period 7151 is a plurality of symbols used to transmit a signal in the slot 715. The time period 7152 is one or more guard symbols in the slot 715.

A plurality of symbols for transmitting signals in the first slot in each FFP are available sidelink time domain units. In other words, a time period 7111, a time period 7131, a time period 7221, and a time period 7241 are valid sidelink time domain units in the FFP 710 to the FFP 740, respectively.

In each FFP, an available time domain unit is a COT part of the FFP, and the other part is an idle period. CCA may be performed by a terminal device in a guard symbol of the second slot. Therefore, CCA for the FFP 710 to the FFP 740 may be performed in a time period 7122, a time period 7142, a time period 7232, and a time period 7252, respectively.

Still referring to FIG. 7, the available time domain units are staggered in the two FFP configurations. The first FFP configuration has 0 slot offsets, and the second FFP configuration has 1 slot offset.

When two terminal devices perform channel access on a resource pool with FFPs shown in FIG. 7 configured, a first terminal device may select the first FFP configuration, and perform transmission from a start time domain location of the FFP 710. A second terminal device may select the second FFP configuration, and perform transmission from a start time domain location of the FFP 730. In other words, two time domain locations at which transmission may start are configured in a duration of one FFP. The two terminal devices do not need to contend for transmission resources of the slot 711 or the slot 721, which helps reduce resource collisions that occur after channel monitoring.

It may be learned from FIG. 7 that time domain units used for transmission by the two terminal devices are staggered, which may avoid a problem mentioned above that the first time domain unit is too congested, and a subsequent time domain unit is not sufficiently used. When more terminal devices perform transmission based on valid time domain units that are staggered, utilization of a resource pool and transmission efficiency are improved.

The foregoing describes that the first FFP may be corresponding to a plurality of configurations, and the first terminal device may select one configuration for sidelink transmission. To avoid any error in transmission, when the first FFP is corresponding to a plurality of configurations, the first terminal device may select only one configuration for use at a same time.

In some embodiments, the first terminal device may independently select a first configuration. A mechanism that a terminal device performs selection independently may be configured or preconfigured by a network device, or may be independently implemented by the terminal device. In some embodiments, when the first terminal device is in coverage of a network device, the network device may directly indicate that the first terminal device uses the first configuration. In some embodiments, when the first terminal device is outside the coverage of the network device, the first terminal device may perform selection based on preconfiguration of the network device.

In some embodiments, the first configuration may be randomly selected. For example, the first terminal device may randomly select one configuration from a plurality of configurations corresponding to the first FFP.

In some embodiments, the first configuration may be selected based on a specific criterion. The specific criterion may be first information associated with a first terminal device and/or a time domain unit corresponding to a configuration.

In a possible implementation, the first information may be associated with measurement results of some or all sidelink time domain units in a plurality of sidelink time domain units included in the first FFP. The some or all sidelink time domain units may be valid sidelink time domain units in the first FFP. For example, the first information may be a sensing result of a valid time domain unit in a plurality of configurations. Specifically, the first terminal device may select the first configuration by using the sensing result.

The measurement result may include a channel busy ratio (CBR) of the some or all sidelink time domain units. For example, the first terminal device may select, based on the measurement result, a first configuration corresponding to a sidelink time domain unit with a lowest CBR.

In a possible implementation, the first information may be associated with a priority of the first terminal device. The priority of the first terminal device may be determined based on a service status of the first terminal device. A service with a higher priority may select a first configuration corresponding to a sidelink time domain unit with a less waiting interval. For example, when transmitting real-time data, the first terminal device may have a relatively high priority.

In a possible implementation, the first information may be associated with a transmission type of the first terminal device. For example, the first terminal device may have transmission types such as unicast transmission, groupcast transmission, and broadcast transmission. Different transmission types require different time domain units. When performing groupcast transmission, the first terminal device may select a first configuration based on a resource required by the groupcast transmission.

In a possible implementation, the first information may be associated with a plurality of types of information in the foregoing information. For example, when transmitting a service with the highest priority, the first terminal device may select a first configuration corresponding to a valid time domain unit with the shortest waiting interval and the lowest CBR.

The first terminal device determines the first configuration based on the first information, so that resources may be effectively used for transmission. When the plurality of terminal devices determine a corresponding configuration based on the first information, valid time domain units that are staggered may meet transmission requirements of different terminal devices, which helps improve use efficiency of an entire spectrum.

As mentioned above, a plurality of configurations are introduced into a resource pool of the first terminal device, so that a plurality of time domain locations at which transmission starts are provided for a terminal device in a duration of one FFP. The network device may implicitly indicate, by using a configuration of the resource pool, a plurality of configurations corresponding to the first FFP. A first configuration may be determined based on the configuration of the resource pool of the first terminal device.

In some embodiments, the network device may configure/preconfigure a plurality of resource pools for the first terminal device. The first terminal device may indirectly select, by selecting a resource pool used for transmission, a first configuration with staggering. In other words, the plurality of resource pools of the first terminal device may be used to implement a function of the plurality of configurations corresponding to the first FFP. For example, in the plurality of configurations, valid time domain units are staggered, and in the plurality of resource pools, available resources in the resource pools may be staggered.

For a manner of determining a quantity of resource pools, reference may be made to a configuration quantity corresponding to the first FFP, for example, 2^{μ}. Details are not described herein again.

An available resource is also determined depending on a terminal device. For example, a resource available to the first terminal device may be an unavailable resource for another terminal device.

The staggering of available resources in the plurality of resource pools may be determined based on a time point at which a plurality of resource pools are aligned. In some embodiments, available resources in different resource pools are not at a same time domain location based on an aligned time point.

In some embodiments, the available resources in the plurality of resource pools may be divided according to a granularity of a sidelink time domain unit. For example, the first sidelink time domain unit in a resource pool 1 is an available resource, and the second sidelink time domain unit is an unavailable resource; and the first sidelink time domain unit in a resource pool 2 is an unavailable resource, and the second sidelink time domain unit is an available resource, and so on. Bitmaps of the plurality of resource pools may reflect staggering of available resources.

For ease of understanding, in a bitmap of a resource pool, 1 indicates an available resource, and 0 indicates an unavailable resource. When a quantity of resource pools is 2, bitmaps of the two sidelink resource pools may be respectively configured as follows:
bitmap of a resource pool 1: (1, 0, 1, 0, . . . ); and
bitmap of a resource pool 2: (0, 1, 0, 1, . . . ).

When a quantity of resource pools is 4, bitmaps of the four sidelink resource pools may be respectively configured as follows:
bitmap of a resource pool 1: (1, 0, 0, 0, 1, 0, 0, 0, . . . );
bitmap of a resource pool 2: (0, 1, 0, 0, 0, 1, 0, 0, . . . );
bitmap of a resource pool 3: (0, 0, 1, 0, 0, 0, 1, 0, . . . ); and
bitmap of a resource pool 4: (0, 0, 0, 1, 0, 0, 0, 1, . . . ).

As described above, time domain locations of available resources in different resource pools are different. A plurality of terminal devices may select different resource pools, so that sidelink transmission is performed at different time domain locations.

In some embodiments, the first terminal device may independently select a resource pool. For example, the first terminal device may select a resource pool based on the foregoing first information.

In some embodiments, the network device may designate a resource pool for the first terminal device. For example, when the first terminal device is in coverage of the network device, the network device may designate a resource pool for the first terminal device based on a use status of entire resources.

It may be learned from the foregoing that this embodiment of the present application provides a method of FBE staggering for sidelink communication on an unlicensed spectrum. In this method, for a sidelink resource pool configured with a subcarrier spacing greater than 15 kHz, a plurality of configurations corresponding to an FFP are introduced. Each configuration has different offsets, so as to implement staggering of valid time domain units in an FBE structure. A terminal device may select an applicable configuration according to a specified rule to perform channel access and sidelink transmission.

The foregoing describes the method embodiments of the present application in detail with reference to FIG. 1 to FIG. 7. The apparatus embodiments of the present application are described in detail below with reference to FIG. 8 to FIG. 9. It should be understood that the description of the apparatus embodiments corresponds to the description of the method embodiments, and therefore, for parts that are not described in detail, reference may be made to the foregoing method embodiments.

FIG. 8 is a schematic block diagram of an apparatus for sidelink communication according to an embodiment of the present application. The apparatus 800 may be any terminal device described above. The apparatus 800 shown in FIG. 8 includes a determining unit 810.

The determining unit 810 may be configured to determine a first configuration corresponding to a first FFP, where the first FFP includes a plurality of sidelink time domain units, and the first configuration is used to indicate a valid sidelink time domain unit in the plurality of sidelink time domain units.

Optionally, the first configuration includes a first parameter, the first parameter is used to indicate a time domain unit offset, and a valid sidelink time domain unit is determined based on the first parameter.

Optionally, the first configuration belongs to one of a plurality of configurations corresponding to the first FFP, and a quantity of configurations corresponding to the first FFP is determined based on a subcarrier spacing of sidelink.

Optionally, the first FFP is corresponding to 2^{μ} configurations, and μ is a parameter determined based on the subcarrier spacing.

Optionally, the first FFP includes 2^{μ} sidelink time domain units, and μ is a parameter determined based on the subcarrier spacing of sidelink.

Optionally, the first configuration is determined based on first information, and the first information is associated with one or more of the following: a measurement result of some or all sidelink time domain units in the plurality of sidelink time domain units; a priority of the first terminal device; and a transmission type of the first terminal device.

Optionally, the measurement result includes a CBR of some or all sidelink time domain units.

Optionally, the first configuration is selected by the first terminal device or configured by a network device.

Optionally, the first configuration is determined based on a resource pool configuration of the first terminal device.

Optionally, a duration of the first FFP is 1 millisecond.

FIG. 9 is a schematic structural diagram of a communications apparatus according to an embodiment of the present application. The dashed lines in FIG. 9 indicate that the unit or module is optional. The apparatus 900 may be configured to implement the methods described in the foregoing method embodiments. The apparatus 900 may be a chip or a terminal device.

The apparatus 900 may include one or more processors 910. The processor 910 may allow the apparatus 900 to implement the methods described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program that may be executed by the processor 910 to cause the processor 910 to perform the methods described in the foregoing method embodiments. The memory 920 may be independent of the processor 910 or may be integrated into the processor 910.

The apparatus 900 may further include a transceiver 930. The processor 910 may communicate with another device or chip through the transceiver 930. For example, the processor 910 may send and receive data to and from another device or chip through the transceiver 930.

An embodiment of the present application further provides a computer-readable storage medium for storing a program. The computer-readable storage medium may be applied to the terminal or the network device provided in the embodiments of the present application, and the program causes a computer to perform the methods to be performed by the terminal device or the network device in various embodiments of the present application.

An embodiment of the present application further provides a computer program product. The computer program product includes a program. The computer program product may be applied to the terminal or the network device provided in the embodiments of the present application, and the program causes a computer to perform the methods to be performed by the terminal device or the network device in various embodiments of the present application.

An embodiment of the present application further provides a computer program. The computer program may be applied to the terminal or the network device provided in the embodiments of the present application, and the computer program causes a computer to perform the methods to be performed by the terminal device or the network device in various embodiments of the present application.

The terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In the embodiments of the present application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In the embodiments of the present application, the term “corresponding” may mean that there is a direct or indirect correspondence between the two, or may mean that there is an association relationship between the two, which may also be a relationship such as indicating and being indicated, or configuring and being configured.

In the embodiments of the present application, “predefined” or “preconfigured” may be 0implemented by pre-storing corresponding codes, tables, or other forms that may be used to indicate related information in devices (for example, including the terminal device and the network device), and a specific implementation thereof is not limited in the present application. For example, pre-defined may refer to defined in the protocol.

In the embodiments of the present application, the “protocol” may refer to a standard protocol in the communications field, and may include, for example, an LTE protocol, an NR protocol, and a related protocol applied to a future communications system, which is not limited in the present application.

In the embodiments of the present application, determining B based on A does not mean determining B based only on A, but instead B may be determined based on A and/or other information.

In the embodiments of the present application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In the embodiments of the present application, sequence numbers of the foregoing processes do not mean execution sequences. The execution sequences of the processes should be determined according to functions and internal logic of the processes, and should not be construed as any limitation on the implementation processes of the embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in the embodiments of the present application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to the embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for sidelink communication, comprising:
determining, by a first terminal device, a first configuration corresponding to a first fixed frame period (FFP),
wherein the first FFP comprises a plurality of sidelink time domain units, the first configuration is used to indicate a valid sidelink time domain unit in the plurality of sidelink time domain units, the first configuration belongs to one of a plurality of configurations corresponding to the first FFP, and a quantity of configurations corresponding to the first FFP is determined based on a subcarrier spacing of sidelink.

2. The method according to claim 1, wherein the first configuration comprises a first parameter, the first parameter is used to indicate a time domain unit offset, and the valid sidelink time domain unit is determined based on the first parameter.

3. The method according to claim 1, wherein the first FFP corresponds to 2^{μ} configurations, and μ is a parameter determined based on the subcarrier spacing.

4. The method according to claim 1, wherein the first FFP comprises 2^{μ} sidelink time domain units, and μ is a parameter determined based on a subcarrier spacing of sidelink.

5. The method according to claim 1, wherein the first configuration is determined based on first information, and the first information is associated with one or more of the following:
a measurement result of some or all sidelink time domain units in the plurality of sidelink time domain units;
a priority of the first terminal device; and
a transmission type of the first terminal device.

6. The method according to claim 5, wherein the measurement result comprises a channel busy ratio of the some or all sidelink time domain units.

7. The method according to claim 1, wherein the first configuration is selected by the first terminal device or configured by a network device.

8. The method according to claim 1, wherein the first configuration is determined based on a resource pool configuration of the first terminal device.

9. The method according to claim 1, wherein a duration of the first FFP is 1 millisecond.

10. An apparatus for side communication, wherein the apparatus is a first terminal device and comprises:
a determining unit, configured to determine a first configuration corresponding to a first fixed frame period (FFP),
wherein the first FFP comprises a plurality of sidelink time domain units, the first configuration is used to indicate a valid sidelink time domain unit in the plurality of sidelink time domain units, the first configuration belongs to one of a plurality of configurations corresponding to the first FFP, and a quantity of configurations corresponding to the first FFP is determined based on a subcarrier spacing of sidelink.

11. The apparatus according to claim 10, wherein the first configuration comprises a first parameter, the first parameter is used to indicate a time domain unit offset, and the valid sidelink time domain unit is determined based on the first parameter.

12. The apparatus according to claim 10, wherein the first FFP corresponds to 2^{μ} configurations, and μ is a parameter determined based on the subcarrier spacing.

13. The apparatus according to claim 10, wherein the first FFP comprises 2^{μ} sidelink time domain units, and μ is a parameter determined based on a subcarrier spacing of sidelink.

14. The apparatus according to claim 10, wherein the first configuration is determined based on first information, and the first information is associated with one or more of the following:
a measurement result of some or all sidelink time domain units in the plurality of sidelink time domain units;
a priority of the first terminal device; and
a transmission type of the first terminal device.

15. The apparatus according to claim 14, wherein the measurement result comprises a channel busy ratio of the some or all sidelink time domain units.

16. The apparatus according to claim 10, wherein the first configuration is selected by the first terminal device or configured by a network device.

17. The apparatus according to claim 10, wherein the first configuration is determined based on a resource pool configuration of the first terminal device.

18. The apparatus according to claim 10, wherein a duration of the first FFP is 1 millisecond.

19. A communications apparatus, comprising a memory and a processor, wherein the memory is configured to store a program, and the processor is configured to invoke the program in the memory to perform the method according to claim 1.

20. A non-transitory computer-readable storage medium, wherein the non-transitory computer-readable storage medium stores a program, and the program causes a computer to perform the method according to claim 1.
